(19) United States
(12) Patent Application Publication
(10) Pub. No.: US 2026/0167089 A1
(43) Pub. Date: Jun. 18, 2026

(54) VEHICLE HEADLAMP DEVICE AIMING METHOD AND VEHICLE HEADLAMP DEVICE AIMING SYSTEM

(71) Applicant: SUBARU CORPORATION, Tokyo (JP)

(72) Inventors: Kentaro YAMASAKI, Tokyo (JP); Makoto KINOSHITA, Tokyo (JP); Noriaki ASANO, Tokyo (JP); Shunichi NAKAMURA, Tokyo (JP)

(21) Appl. No.: 18/853,797

(22) PCT Filed: Sep. 6, 2023
(86) PCT No.: PCT/JP2023/032518

§ 371 Date: Oct. 3, 2024

(51) Int. Cl. B60Q 1/068; F21S 41/657

(52) U.S. Cl. CPC B60Q 1/068; F21S 41/657; B60Q 2200/30

(57) ABSTRACT

A vehicle headlamp device aiming method controls a light distribution pattern of a headlamp device, based on a front image of an own vehicle acquired by an in-vehicle camera. The vehicle headlamp device aiming method includes: a step of illuminating an aiming screen with a specific light distribution pattern in the headlamp device, and acquiring an image of the specific light distribution pattern by the in-vehicle camera; a step of obtaining coordinates of a specific position in the specific light distribution pattern, by using coordinates set on the image of the in-vehicle camera, and obtaining a deviation with respect to adjusted coordinates of the specific position; and a step of performing optical axis adjustment of the headlamp device to eliminate the deviation.

### TECHNICAL FIELD

The invention relates to a vehicle headlamp device aiming method and a vehicle headlamp device aiming system.

### BACKGROUND ART

When a vehicle headlamp device is assembled to a vehicle body, aiming is performed to adjust a direction of an optical axis. A system that performs aiming automatically has been proposed in order to eliminate variation of the aiming due to human work. In a fixed attitude of a vehicle, the system illuminates a screen installed in front of the vehicle with a predetermined light distribution pattern by a lamp unit of a headlamp device. The system acquires a deviation between a target position of the light distribution pattern and a reference position in front of the vehicle corresponding to the target position, based on image information of an imaging device. The system drives an optical axis displacement unit in a such a manner that the target position of the light distribution pattern and the reference position in front of the vehicle match each other by using the acquired information on the deviation (see Patent Document 1 below).

In addition, recent vehicles are equipped with a variable light distribution system for a vehicle headlight, called ADB (Adaptive Driving Beam). The variable light distribution system variably controls high-beam and low-beam light distribution patterns based on an acquired image of an in-vehicle camera that acquires an image in front of the vehicle, in order to suppress glare for a driver of a front vehicle or an oncoming vehicle (Patent Document 2 below).

### CITATION LIST

### Patent Literature

Patent Literature 1: Japanese Patent No. 5331803

Patent Literature 2: Japanese Unexamined Patent Application Publication No. 2014-136505

### SUMMARY OF INVENTION

### Problem to be Solved by the Invention

In a headlamp device including the variable light distribution system (ADB) described above, in aiming when replacing the headlamp device, for example, calibrated has to be performed to align a direction of an optical axis of an in-vehicle camera that acquires a vehicle front image to be used for ADB control with a direction of an optical axis of the headlamp device. If this is performed by the existing aiming system described above, in a first step, calibration is performed to drive an optical axis displacement unit of the headlamp device in such a manner that a target position of a light distribution pattern matches a reference position in front of the vehicle. Thereafter, in a second step, adjustment has to be performed to make the optical axis of the in-vehicle camera match the reference position in front of the vehicle. This causes an issue of necessity to perform two-step complicated adjustment.

The invention aims to address such a circumstance. In other words, an object of the invention is to, for example, in aiming of a vehicle headlamp device including a variable light distribution system that controls a light distribution pattern based on an acquired image of an in-vehicle camera, enable simple and accurate optical axis adjustment while ensuring accuracy of the variable light distribution system.

### Means for Solving the Problem

To solve the above-described problem, an aspect of the invention provides a vehicle headlamp device aiming method that controls a light distribution pattern of a headlamp device, based on a front image of an own vehicle acquired by an in-vehicle camera. The vehicle headlamp device aiming method includes: illuminating an aiming screen with a specific light distribution pattern in the headlamp device, and acquiring an image of the specific light distribution pattern by the in-vehicle camera; obtaining coordinates of a specific position in the specific light distribution pattern, by using coordinates set on the image of the in-vehicle camera, and obtaining a deviation with respect to adjusted coordinates of the specific position; and performing optical axis adjustment of the headlamp device to eliminate the deviation.

In addition, an aspect of the invention provides a vehicle headlamp device aiming system including an in-vehicle camera, a headlamp device, and a control device. The in-vehicle camera is configured to acquire a front image of an own vehicle. The headlamp device is configured to emit a specific light distribution pattern in front of the own vehicle. The control device is configured to control a light distribution pattern of the headlamp device, based on the front image of the own vehicle acquired by the in-vehicle camera. The control device is configured to illuminate an aiming screen with the specific light distribution pattern in the headlamp device, acquire an image of the specific light distribution pattern by the in-vehicle camera, obtain coordinates of a specific position in the specific light distribution pattern, by using coordinates set on the image of the in-vehicle camera, and perform optical axis adjustment of the headlamp device to eliminate a deviation with respect to adjusted coordinates of the specific position.

### Effects of the Invention

According to the invention having such characteristics, in aiming of the vehicle headlamp device including the variable light distribution system that controls the light distribution pattern based on the acquired image of the in-vehicle camera, it is possible to simply and accurately perform optical axis adjustment while ensuring accuracy of the variable light distribution system.

### BRIEF DESCRIPTION OF DRAWINGS

FIG. 1 is an explanatory diagram illustrating a vehicle headlamp device aiming system according to an embodiment of the invention.

FIG. 2 is an explanatory diagram (front view) illustrating a configuration example of a headlamp device.

FIG. 3 is an explanatory diagram illustrating a hardware configuration of an ECU.

FIG. 4 is an explanatory diagram illustrating an operation flow of an initial setting operation mode.

FIG. 5 is an explanatory diagram illustrating an image of a specific light distribution pattern (low-beam light distribution pattern) and coordinates of a specific position at the time of initial setting.

FIG. 6 is an explanatory diagram illustrating an image of a specific light distribution pattern (high-beam light distribution pattern) and coordinates of a specific position at the time of initial setting.

FIG. 7 is an explanatory diagram illustrating an operation flow of an optical axis adjustment operation mode.

FIG. 8 is an explanatory diagram illustrating an image of a specific light distribution pattern (low-beam light distribution pattern) and coordinates of a specific position at the time of optical axis adjustment.

FIG. 9 is an explanatory diagram illustrating an operation flow of an ADB control operation mode.

### MODES FOR CARRYING OUT THE INVENTION

Some embodiments of the invention are described below with reference to the drawings. In the following description, the same reference numerals in different drawings indicate parts with the same functions, and redundant description in each drawing is omitted as appropriate.

A vehicle headlamp device aiming system (hereinafter, system) 1 according to an embodiment of the invention is mounted on a vehicle B, and includes an in-vehicle camera 2, a headlamp device 3, and a control device 10. An aiming screen S with an illumination target surface Sa to be opposed to the in-vehicle camera 2 and the headlamp device 3 is also provided as a facility for aiming operation of the system 1.

The in-vehicle camera 2 is configured to capture at least a front image of the vehicle B serving as an own vehicle, and is, for example, a camera that acquires a detected image to be used for an ADAS (Advanced Driving Assistant System). When ADB control is performed, the in-vehicle camera 2 acquires the front image of the vehicle B in order to identify a front vehicle or an oncoming vehicle that is a target of glare suppression. In addition, the in-vehicle camera 2 captures an image of a light distribution pattern of the headlamp device 3 emitted to illuminate the illumination target surface Sa of the aiming screen S in a darkroom at the time of initial setting or optical axis adjustment.

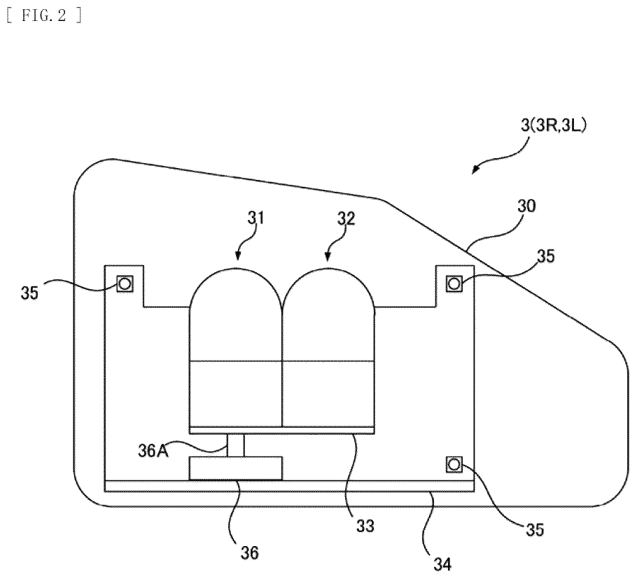

The headlamp device 3 is mounted on left and right ends at the front of the vehicle B. A right headlamp device 3R and a left headlamp device 3L of the headlamp device 3 are bilaterally symmetrical and have the same structure. FIG. 2 illustrates only one side of the headlamp device 3 (the right headlamp device 3R). As illustrated in FIG. 2, the headlamp device 3 (the right headlamp device 3R and the left headlamp device 3L) includes a lamp housing 30, a low-beam lamp unit 31, a high-beam lamp unit 32, a heat sink member 33, a bracket 34, an optical axis adjustment device 35, a swivel device 36, and a lamp lens (not illustrated).

The optical axis adjustment device 35 allows for adjustment of a mounting angle of the bracket 34 with respect to the lamp housing 30 by three-point support, and is configured to adjust optical axes of the low-beam lamp unit 31 and the high-beam lamp unit 32. In addition, the swivel device 36 includes a drive unit that rotationally drives a rotary shaft 36A based on a control signal, and uses the rotation of the rotary shaft 36A to rotationally drive the low-beam lamp unit 31 and the high-beam lamp unit 32 supported by the heat sink member 33, around a vertical axis.

The swivel device 36 cooperates with the optical axis adjustment device 35 as an actuator that performs optical axis adjustment of the headlamp device 3. In addition, the swivel device 36 rotationally drives the low beam lamp unit 31 and the high beam lamp unit 32 around the vertical axis by an output of the control device 10 based on a signal from a steering angle sensor (not illustrated) as well as a signal from the in-vehicle camera 2.

The low-beam lamp unit 31 and the high-beam lamp unit 32 are each, for example, configured to individually turn on and off segmented multiple illumination units (lighting segments), and may include, for example, an LED (Light Emitting Diode) array or MEMS (Micro Electro Mechanical Systems) devices such as DMDs (Digital Micromirror Devices).

The control unit 10 includes multiple in-vehicle ECUs (Electronic Control Units). One of the in-vehicle ECUs included in the control unit 10 is an ECU 11 for in-vehicle camera control. Image data captured by the in-vehicle camera 2 is transmitted to the ECU 11, and the in-vehicle camera 2 is controlled by an output from the ECU 11. Another one of the ECUs included in the control unit 10 is an ECU 12 for headlamp device control. The ECU 12 controls lighting of the headlamp device 3 in the illumination units to form a specific light distribution pattern, and controls the optical axis adjustment device 35 and the swivel device 36 serving as an actuator that performs optical axis adjustment of the headlamp device 3.

The ECUs 11 and 12 in the control device 10 are communicably coupled to each other by an in-vehicle network 13 such as a CAN (Controller Area Network) or a LIN (Local Interconnect Network). In addition, the ECUs 11 and 12 are coupled to a central gateway (CGW ECU) 14 as a relay device, and communicably coupled to another in-vehicle ECU, which is not illustrated.

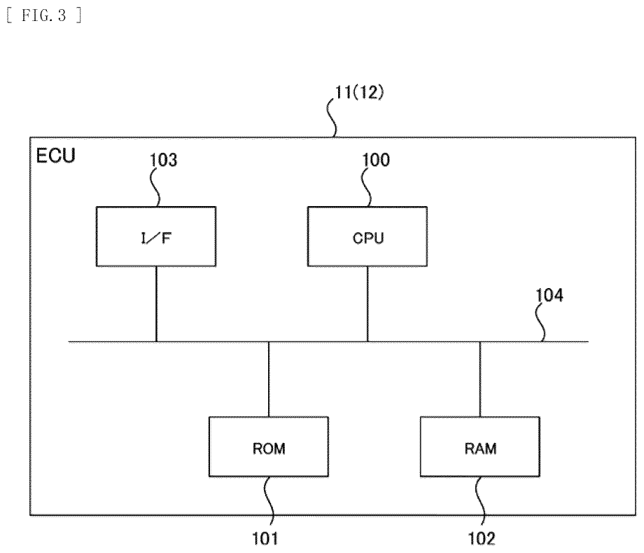

As illustrated in FIG. 3, the ECUs 11 and 12 each include a CPU (Central Processing Unit) 100, a ROM (Read Only Memory) 101, a RAM (Random Access Memory) 102, an I/F (Interface) 103, and the like, and the pieces of hardware are coupled to each other via a bus 104. The CPU 100 controls operation of the ECUs 11 and 12 by executing various programs stored in the ROM 101. The ROM 101 is a non-volatile memory. For example, the ROM 101 stores the program to be executed by the CPU 100 and information necessary for the CPU 100 to execute the program. The RAM 102 is a main storage device such as a DRAM (Dynamic Random Access Memory) or a SRAM (Static Random Access Memory). For example, the RAM 102 serves as a work area that the CPU 100 uses to execute the program. The I/F 103 controls transmission and reception of information to and from an external device (for example, the in-vehicle camera 2 or the headlamp device 3).

Control of the system 1 performed by the control device 10 includes at least an initial setting operation mode, an optical axis adjustment operation mode, and an ADB control operation mode. An aiming method for the headlamp device 3 by the system 1 is executable by the initial setting operation mode and the optical axis adjustment operation mode.

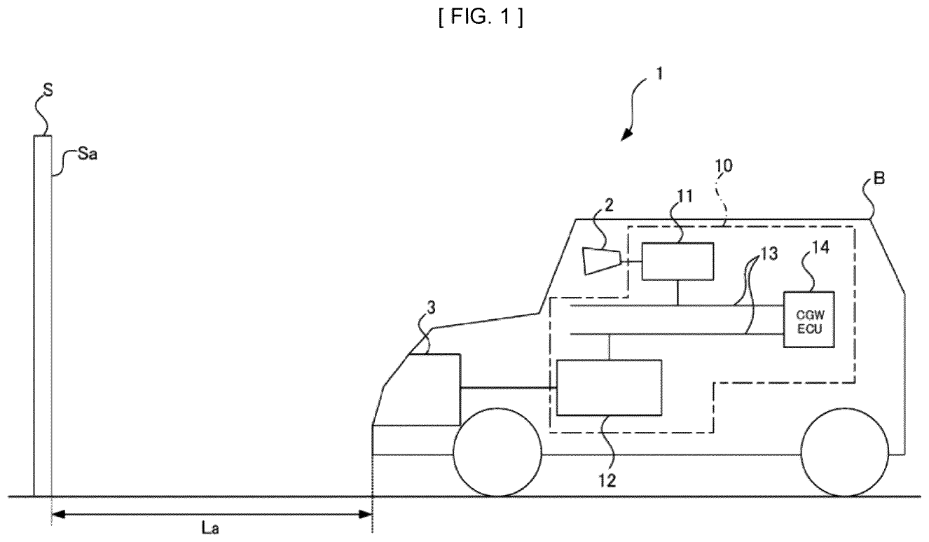

In the initial setting operation mode, as illustrated in FIG. 1, the vehicle B is installed under initial setting conditions with respect to the aiming screen S, the illumination target surface Sa of the aiming screen S is illuminated with a specific light distribution pattern from the headlamp device 3 in a darkroom, and an image of the specific light distribution pattern illuminating the illumination target surface Sa is captured by the in-vehicle camera 2. The initial setting conditions include, for example, a distance La from the aiming screen S to a front end of the vehicle B.

At the time of initial setting of the initial setting operation mode, optical axes of the headlamp device 3 and the in-vehicle camera 2 appropriately mounted on the vehicle B have been adjusted in advance. Therefore, a glare suppression function of the ADB control functions normally as long as this state at the time of initial setting is maintained.

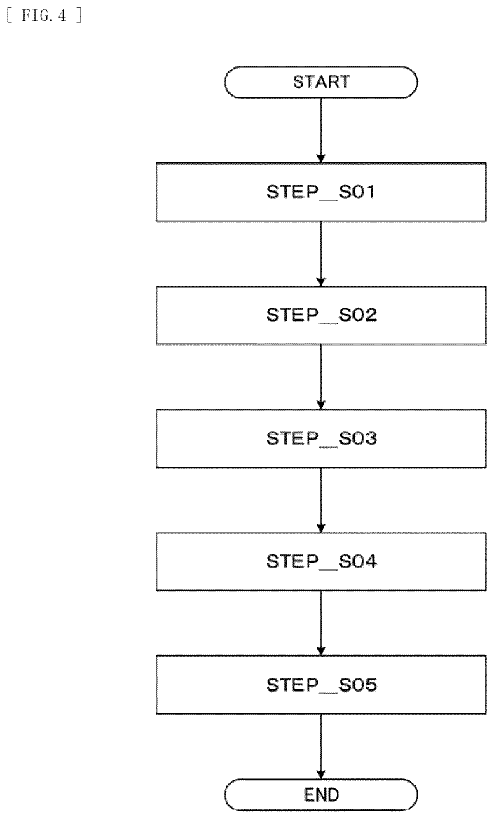

Now described is an operation example of the initial setting operation mode with reference to FIG. 4. When the initial setting operation is started (START), the following steps are executed and the process is ended (END). The initial setting conditions described above are prepared (STEP_S01). A specific light distribution pattern in the headlamp device 3 is set to illuminate the illumination target surface Sa of the aiming screen S with the specific light distribution pattern (STEP_S02). An image of the light distribution pattern projected onto the illumination target surface Sa of the aiming screen S is acquired by the in-vehicle camera 2 (STEP_S03). By image processing on the acquired image, coordinates of a specific position of the specific light distribution pattern are obtained using coordinates (X-Y coordinates) set on the image (STEP_S04). Obtained coordinate information on the specific position is stored in a storage of the control device 10 (STEP_S05). The coordinates of the specific position obtained in the initial setting operation mode correspond to adjusted coordinates of the specific position.

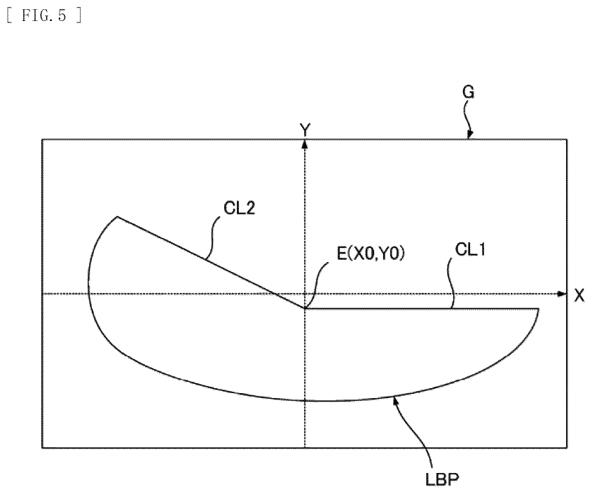

FIG. 5 illustrates, as an example, a case where a low-beam light distribution pattern LBP is set as the specific light distribution pattern. The low-beam light distribution pattern LBP emitted to illuminate the aiming screen S by the headlamp device 3 has a horizontal cut-off line CL1 and a diagonal cut-off line CL2, and has an elbow point E that is an intersection of the horizontal cut-off line CL1 and the diagonal cut-off line CL2. In the illustrated example, coordinates E (X0, Y0) of the elbow point E serving as the specific position of the low-beam light distribution pattern LBP are obtained using the X-Y coordinates set on an image G captured by the in-vehicle camera 2, and the coordinates are stored in the storage of the control device 10 as the adjusted coordinates.

Here, the specific position of the low-beam light distribution pattern LBP is the elbow point E, but the specific position is not limited thereto. For example, a part or all of the horizontal cut-off line CL1 or a part or all of the diagonal cut-off line CL2 may be set as the specific position.

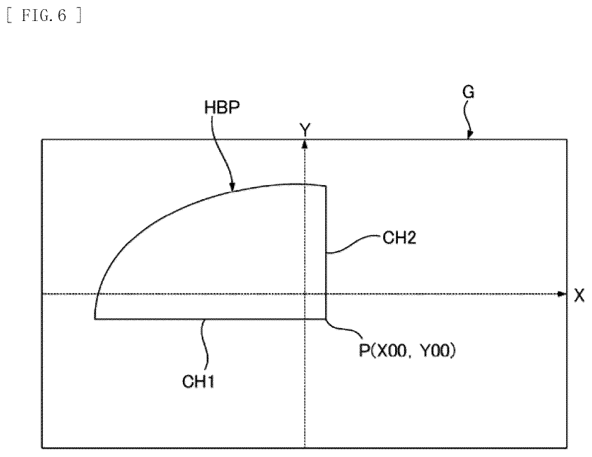

FIG. 6 illustrates, as an example, a case where a high-beam light distribution pattern HBP is set as the specific light distribution pattern. The high-beam light distribution pattern HBP emitted to illuminate the aiming screen S by the headlamp device 3 has a horizontal cut-off line CHI and a vertical cut-off line CH2, and has an intersection P of the horizontal cut-off line CH1 and the vertical cut-off line CH2. In the illustrated example, coordinates P (X00, Y00) of the intersection P serving as the specific position of the high-beam light distribution pattern HBP are obtained using the X-Y coordinates set on the image G captured by the in-vehicle camera 2, and the coordinates are stored in the storage of the control device 10 as the adjusted coordinates.

Here, the specific position of the high-beam light distribution pattern HBP is the intersection P, but the specific position is not limited thereto. For example, a part or all of the horizontal cut-off line CH1 or a part or all of the vertical cut-off line CH2 may be set as the specific position.

The optical axis adjustment operation mode is an operation mode performed when replacing the headlamp device 3, for example. A deviation that occurs between the coordinates (adjusted coordinates) of the light distribution pattern stored in the initial setting operation mode and the coordinates of the specific position of the light distribution pattern obtained after replacement of the headlamp device 3 is detected, and optical axis adjustment is performed to eliminate the deviation.

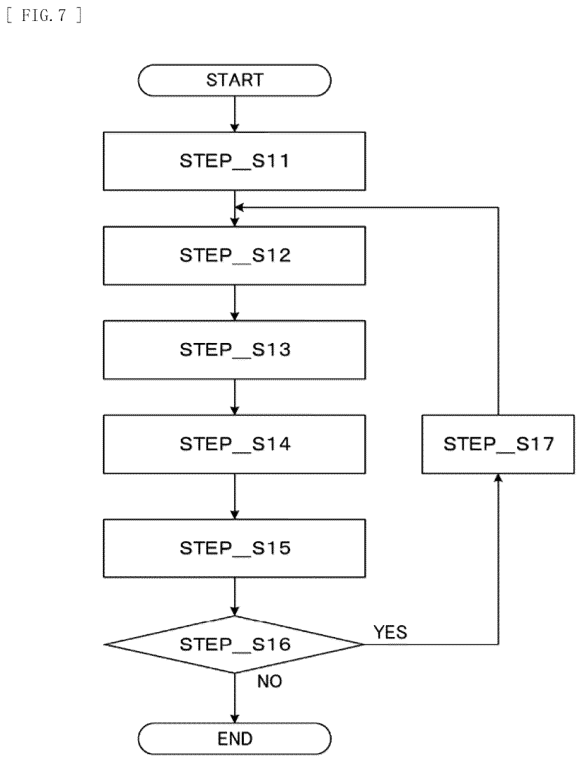

Now described is an operation example of the optical axis adjustment operation mode with reference to FIG. 7. When the optical axis adjustment operation is started (START), the following steps are executed and the process is ended (END). The initial setting conditions described above are reproduced (STEP_S11). The illumination target surface Sa of the aiming screen S is illuminated with the specific light distribution pattern in the headlamp device 3 (STEP_S12). An image of the light distribution pattern illuminating the illumination target surface Sa of the aiming screen S is acquired by the in-vehicle camera 2 (STEP_S13).

By image processing on the acquired image, the coordinates of the specific position of the specific light distribution pattern are obtained using the coordinates (X-Y coordinates) set on the image (STEP_S14). Further, a deviation between the coordinates of the specific position obtained here and the coordinates (adjusted coordinates) of the specific position stored in the initial setting operation mode is detected (STEP_S15). When there is a deviation (STEP_S16: YES), the actuator for optical axis adjustment (the optical axis adjustment device 35 and the swivel device 36) is driven to perform optical axis adjustment to eliminate the deviation (STEP_S17). Thereafter, steps from STEP_S12 to STEP_S15 described above are performed, and the process is ended (END) when the deviation is eliminated (STEP_S16: NO).

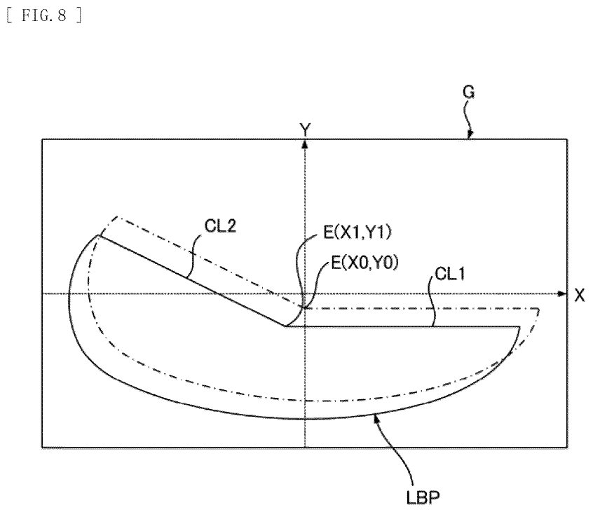

When replacing the headlamp device 3, for example, the optical axis of the headlamp device 3 can deviate from that at the time of initial installation. In this case, an image of the light distribution pattern of the headlamp device 3 emitted to illuminate the aiming screen S with the initial setting conditions reproduced is captured by the in-vehicle camera 2, and the coordinates of the specific position of the light distribution pattern are acquired. The coordinates of the specific position deviate from E (X0, Y0) to E (X1, Y1), as illustrated in FIG. 8, and optical axis adjustment is performed based on the deviation.

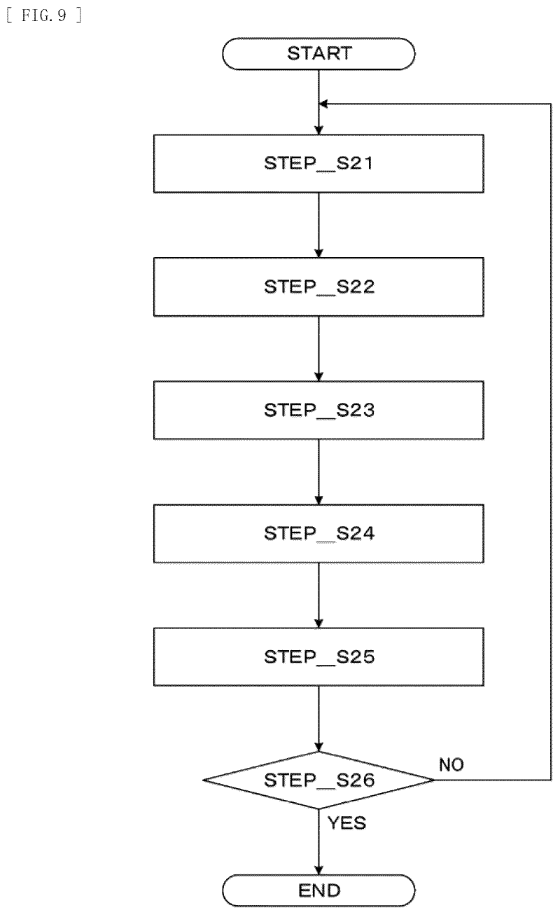

The ADB control operation mode is variable light distribution control of the headlamp device 3, performed when the vehicle is traveling. As illustrated in FIG. 9, when the ADB control is started (START), the following steps are executed and the process is ended (END). A front image is acquired by the in-vehicle camera 2 (STEP_S21). A light-blocking target in the acquired image is identified by image processing on the acquired front image (STEP_S22). A light-blocking region on the acquired image is determined (STEP_S23).

When the light-blocking region on the image is determined, a light distribution pattern of the headlamp device 3 corresponding to the light-blocking region is determined (STEP_S24). Lighting of the headlamp device 3 is controlled based on the determined light distribution pattern (STEP_S25). Thus, it is possible to execute appropriate ADB control with suppressed glare for the light-blocking target. Further, the above-described steps from STEP_S21 to STEP_S25 are repeated in a case of continuing such ADB control (STEP_S26: NO), and the control operation is ended (END) in a case of ending the ADB control (STEP_S26: YES).

When the ADB control is executed, the light distribution pattern of the headlamp device 3 is determined to perform light-blocking (or light reduction) for the light-blocking region determined from the acquired image of the in-vehicle camera 2. Even if a deviation occurs between the optical axis of the headlamp device 3 and the vehicle body or the optical axis of the in-vehicle camera 2 due to, for example, replacement of the headlamp device 3, executing the above-described optical axis adjustment operation mode makes it possible to align the optical axis of the headlamp device 3 with the optical axis of the in-vehicle camera 2 without performing complicated two-step adjustment, and to perform appropriate ADB control to suppress glare for the light-blocking target.

In the above-described embodiment, optical axis adjustment is performed in the optical axis adjustment operation mode, but the position of the light distribution pattern in the ADB control may be corrected based on the deviation of the specific position of the light distribution pattern obtained in the optical axis adjustment operation mode, without performing optical axis adjustment. Thus, when there is a deviation between the optical axis of the headlamp device 3 and the optical axis of the in-vehicle camera 2, it is possible to perform appropriate ADB control to suppress glare for the light-blocking target.

Although some embodiments of the invention have been described with reference to the drawings, specific configurations are not limited to these embodiments, and the invention includes modifications of design or the like made within a range not departing from the gist of the invention. Further, the above-described embodiments may be combined by diverting the technologies to each other as long as there is no particular contradiction or issue in the purpose, configuration, or the like.

### Description of Reference Numerals

1: aiming system (system), 2: in-vehicle camera, 3: headlamp device, 3R: right headlamp device, 3L: left headlamp device, 10: control device, 11, 12: ECU, 13: in-vehicle network, 14: central gateway, 30: lamp housing, 31: low-beam lamp unit, 32: high-beam lamp unit, 33: heat sink member, 34: bracket, 35: optical axis adjustment device, 36: swivel device, 36A: rotary shaft, 100: CPU, 101: ROM, 102: RAM, 103: I/F, 104: bus, B: vehicle, S: aiming screen, Sa: illumination target surface, LBP: low-beam light distribution pattern, HBP: high-beam light distribution pattern, CL1, CH1: horizontal cut-off line, CL2: diagonal cut-off line, CH2: vertical cut-off line, G: image

1. A vehicle headlamp device aiming method that controls a light distribution pattern of a headlamp device, based on a front image of an own vehicle acquired by an in-vehicle camera, the vehicle headlamp device aiming method comprising:
illuminating an aiming screen with a specific light distribution pattern in the headlamp device, and acquiring an image of the specific light distribution pattern by the in-vehicle camera;
obtaining coordinates of a specific position in the specific light distribution pattern, by using coordinates set on the image of the in-vehicle camera, and obtaining a deviation with respect to adjusted coordinates of the specific position; and
performing optical axis adjustment of the headlamp device to eliminate the deviation.

2. The vehicle headlamp device aiming method according to claim 1, wherein the specific position comprises an elbow point of a low-beam light distribution pattern.

3. The vehicle headlamp device aiming method according to claim 1, wherein the specific position comprises a part or all of a cut-off line of a low-beam light distribution pattern.

4. The vehicle headlamp device aiming method according to claim 1, wherein the specific position comprises a part or all of a cut-off line of a high-beam light distribution pattern.

5. A vehicle headlamp device aiming system comprising:
an in-vehicle camera configured to acquire a front image of an own vehicle;
a headlamp device configured to emit a specific light distribution pattern in front of the own vehicle; and
a control device configured to control a light distribution pattern of the headlamp device, based on the front image of the own vehicle acquired by the in-vehicle camera, wherein
the control device is configured to illuminate an aiming screen with the specific light distribution pattern in the headlamp device, acquire an image of the specific light distribution pattern by the in-vehicle camera, obtain coordinates of a specific position in the specific light distribution pattern, by using coordinates set on the image of the in-vehicle camera, and perform optical axis adjustment of the headlamp device to eliminate a deviation with respect to adjusted coordinates of the specific position.

6. A vehicle headlamp device aiming system comprising:
an in-vehicle camera configured to acquire a front image of an own vehicle;
a headlamp device including a lamp and configured to emit a specific light distribution pattern in front of the own vehicle; and
circuitry configured to control a light distribution pattern of the headlamp device, based on the front image of the own vehicle acquired by the in-vehicle camera, wherein
the circuitry is configured to illuminate an aiming screen with the specific light distribution pattern in the headlamp device, acquire an image of the specific light distribution pattern by the in-vehicle camera, obtain coordinates of a specific position in the specific light distribution pattern, by using coordinates set on the image of the in-vehicle camera, and perform optical axis adjustment of the headlamp device to eliminate a deviation with respect to adjusted coordinates of the specific position.
